(19) United States
(12) Patent Application Publication
(10) Pub. No.: US 2014/0147827 A1
(43) Pub. Date: May 29, 2014

(54) SYSTEM FOR DOWNLOADINGING STUDENT HOMEWORK AND ANALYZING HOMEWORK AND METHOD THEREOF

(71) Applicants: INVENTEC (PUDONG) TECHNOLOGY CORPORATION, (US); INVENTEC CORPORATION, Taipei (TW)

(72) Inventor: Ke DING, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/804,441

(22) Filed: Mar. 14, 2013

(30) Foreign Application Priority Data
Nov. 29, 2012 (CN) 201210501620.4

(51) Int. Cl. G09B 5/00

(52) U.S. Cl. CPC G09B 5/00
USPC 434/362

(57) ABSTRACT

A system for downloading student homework and analyzing homework and a method thereof are provided. A teacher uploads a lesson file to a server through a data providing client for a student to download the lesson file conveniently, and the student uploads a homework file to the server through a mobile client for the server to find wrong answer content to perform answering content similarity analysis and provide an analysis result to the data providing client, so as to achieve the technical efficacy of providing digital homework to a student conveniently and analyzing student homework plagiarism fast.

### BACKGROUND OF THE INVENTION

1. Field of the Invention

The present invention relates to a downloading and analyzing system and a method thereof, and more particularly to a system for downloading student homework and analyzing homework and a method thereof.

2. Description of Related Art

Conventional teaching is performed through paper writing, namely, a student needs to carry a textbook and take notes of lesson content of a teacher in a classroom, and the teacher further needs to prepare homework so that the student can also learn at home after class. But it needs to cost massive amounts of paper, so conventional teaching for learning through paper is not suitable for the current society with soaring environmental protection awareness.

Also, with fast development of sciences and technologies, more and more mobile devices are developed, such as: a tablet computer, a smartphone and a notebook computer, and the mobile devices are gradually applied to the teaching, which makes the teaching enter the digital age. Besides that paper waste may be avoided, digital teaching is able to further provide convenience for student learning and teacher teaching, which is also one of the main development directions currently.

But for the digital learning, the convenience of teaching often causes laziness of the student, namely, when the teacher assigns homework in a digital manner, due to data transmission convenience of the mobile device, the student writes the homework in a plagiarizing manner (namely, by copying and pasting) instead of doing the homework earnestly, which will cause shortage of learning efficiency. Additionally, how the teacher provides digital homework is also a problem required to be solved.

To sum up, it can be known that in the prior art, the problem that digital homework is provided inconveniently and plagiarism of the digital homework is compared inconveniently exists for a long time, so it is actually necessary to propose improved technical means to solve this problem.

### SUMMARY OF THE INVENTION

In view of the problem existing in the prior art that digital homework is provided inconveniently and plagiarism of the digital homework is compared inconveniently, the present invention discloses a system for downloading student homework and analyzing homework and a method thereof.

The system for downloading student homework and analyzing homework disclosed in the present invention includes: a server, a data providing client and plurality of mobile clients. The server further includes: a receiving module, a comparing module, an analyzing module, a generating module and a transmitting module.

The receiving module of the server is used for receiving a lesson file and receiving a plurality of homework files; the comparing module of the server is used for comparing answer content of an answer area in the homework file with a corresponding standard answer; the analyzing module of the server is used for, when the comparing module finds through comparison that the answer content is inconsistent with the standard answer, extracting answering content of an answering area corresponding to the answer content in each homework file and performing similarity analysis on any two pieces of answering content to calculate a plurality of similarity values; the generating module of the server is used for generating a student number of the homework file with the similarity value exceeding a preset value into a plagiarizing list; and the transmitting module of the server is used for transmitting the lesson file and transmitting the plagiarizing list.

The data providing client is used for establishing a connection with the server, providing the lesson file to the receiving module, and obtaining the plagiarizing list from the transmitting module; and the plurality of mobile clients is used for establishing connections with the server separately, obtaining the lesson file from the transmitting module, and providing the homework file to the receiving module.

The method for downloading student homework and analyzing homework disclosed in the present invention includes the following steps.

First, a data providing client establishes a connection with a server, and provides a lesson file to the server; next, plurality of mobile clients establishes connections with the server separately, and obtains the lesson file from the server; next, a mobile client provides a homework file to the server separately; next, the server compares answer content of an answer area in the homework file with a corresponding standard answer; next, when the server finds through comparison that the answer content is inconsistent with the standard answer, the server extracts answering content of an answering area corresponding to the answer content in each homework file and performs similarity analysis on any two pieces of answering content to calculate a plurality of similarity values; next, the server generates a student number of the homework file with the similarity value exceeding a preset value into a plagiarizing list; and finally, the server provides the plagiarizing list to the data providing client.

The system and the method disclosed in the present invention are described as above, and the difference between the present invention and the prior art lies in that in the present invention, a teacher may upload a lesson file to a server through a data providing client for a student to download the lesson file conveniently, and when the student uploads a homework file to the server through a mobile client, the server may find wrong answer content to perform similarity analysis on any two pieces of answering content and calculate a plurality of similarity values, and provide a student number of the homework file with the similarity value exceeding a preset value to the data providing client, so the teacher may know the plagiarism situation of student homework fast.

Through the foregoing technical means, the present invention may achieve the technical efficacy of providing digital homework to a student conveniently and analyzing student homework plagiarism fast.

### BRIEF DESCRIPTION OF THE DRAWINGS

The invention will become more fully understood from the detailed description given herein below illustration only, and thus is not limitative of the present invention, and wherein:

FIG. 1 is a block diagram of a system for downloading student homework and analyzing homework of the present invention.

FIG. 2 is a flow chart of a method for downloading student homework and analyzing homework of the present invention.

FIG. 3 is a schematic diagram of an architecture for downloading student homework and analyzing homework of the present invention.

FIG. 4 is a schematic diagram of a lesson file for downloading student homework and analyzing homework of the present invention.

FIG. 5A is a schematic diagram of a first homework file for downloading student homework and analyzing homework of the present invention.

FIG. 5B a schematic diagram of a second homework file for downloading student homework and analyzing homework of the present invention.

FIG. 5C is a schematic diagram of a third homework file for downloading student homework and analyzing homework of the present invention.

### DESCRIPTION OF THE EMBODIMENTS

Implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly.

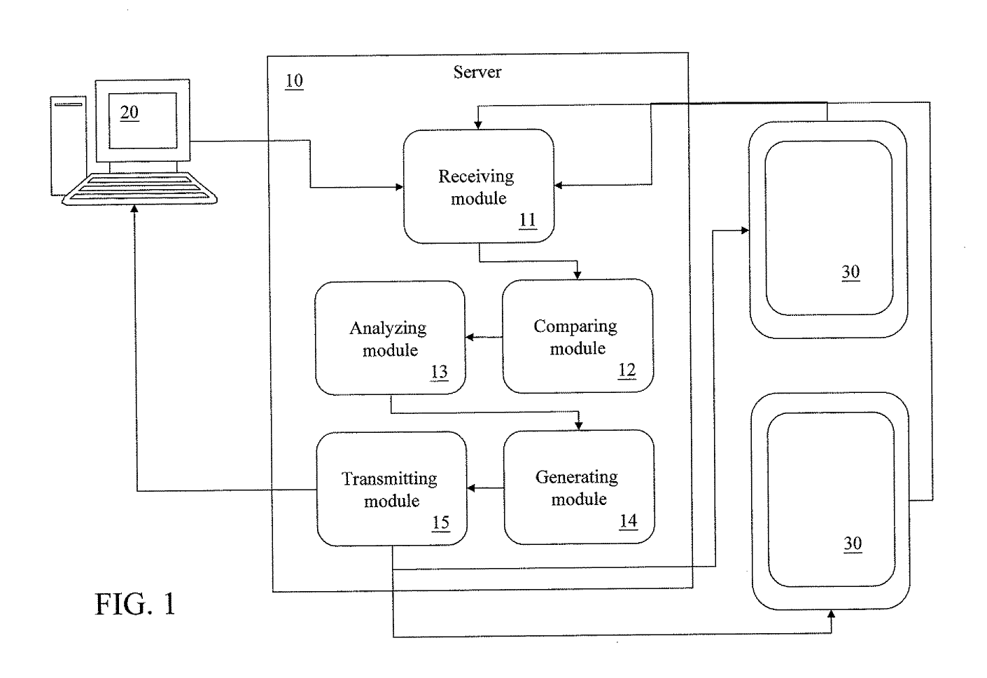

First, the system for downloading student homework and analyzing homework disclosed in the present invention is illustrated below, and referring to FIG. 1, FIG. 1 is a block diagram of a system for downloading student homework and analyzing homework of the present invention.

The system for downloading student homework and analyzing homework disclosed in present invention includes: a server 10, a data providing client 20 and plurality of mobile clients 30. The server 10 further includes: a receiving module 11, a comparing module 12, an analyzing module 13, a generating module 14 and a transmitting module 15.

A teacher first uploads a lesson file to the server 10 through the data providing client 20. The lesson file includes a question area, an answering area and an answer area, where the question area is the question content assigned by a teacher, the answering area is answering process content for the question of a student, and the answer area is the answer content for the question of the student. When the data providing client 20 needs to upload the lesson file to the server 10, the data providing client 20 establishes a connection with the server 10 (the data providing client 20 may establish a connection with the server 10 in a wired transmission manner or a wireless transmission manner, where the wired transmission manner is such as: a wired network, and a transmission line, and the wireless transmission manner is such as: a wireless network, WIFI, and Bluetooth, which are merely exemplified herein, and do not limit the application scope of the present invention). The data providing client 20 may provide the lesson file to the receiving module 11 of the server 10, and the forgoing data providing client 20 may be a desktop computer, a notebook computer, a tablet computer, a smartphone, and so on, which are merely exemplified herein, and do not limit the application scope of the present invention.

After receiving the lesson file provided by the data providing client 20, the receiving module 11 of the server 10 may store the lesson file in the server 10. When the student writes homework, the student obtains the lesson file from the server 10 through the mobile client 30 held by the student to write the homework. The mobile client 30 establishes a connection with the server 10 (the mobile client 30 may establish a connection with the server 10 in a wireless transmission manner, where the wireless transmission manner is such as: a wireless network, WIFI and Bluetooth, which are merely exemplified, and do not limit the application scope of the present invention). The transmitting module 15 of the server 10 transmits the lesson file to the mobile client 30, the mobile client 30 may obtain the lesson file from the server 10, and the forgoing mobile client 30 may be a portable device such as a notebook computer, a tablet computer and a smartphone, which are merely exemplified herein, and do not limit the application scope of the present invention.

After the student obtains the lesson file from the server 10 through the mobile client 30, the student may record the answering process in the answering area of the lesson file, and record the answer in the answer area of the lesson file. After completing the answering, the student establishes a homework file, where the homework file includes the student number of the student, and the homework file may further be provided to the server 10 through the mobile client 30.

After receiving the homework file provided by each mobile client 30, the receiving module 11 of the server 10 may compare answer content of the answer area in the homework file with a corresponding standard answer through the comparing module 12 of the server 10, and when the comparing module 12 of the server 10 finds through comparison a comparison result that the answer content is inconsistent with the standard answer, the analyzing module 13 of the server 10 extracts answering content of an answering area corresponding to the answer content in each homework file and performs similarity analysis on any two pieces of answering content to calculate a plurality of similarity values.

Specifically, it is assumed that answering content of a certain answering area of a first homework file is “2x+2x=4x” and answer content of an answer area corresponding to the answering area is “4x”; it is assumed that answering content of an answering area, corresponding to the first homework file, of a second homework file is “2x+2x=4x” and answer content of an answer area corresponding to the answering area is “4x”; and it is assumed that answering content of an answering area, corresponding to the first homework file, of a third homework file is “1x+3x=4x” and answer content of an answer area corresponding to the answering area is “4x”; a standard answer corresponding to the answer content is “5x”.

The comparing module 12 of the server 10 compares the answer content “4x” of the answer area in the homework file with the standard answer “5x”, and may find through comparison that the answer content “4x” of the answer area is inconsistent with the standard answer “5x”. At this time, the analyzing module 13 of the server 10 extracts the answering content “2x+2x=4x” of the answering area corresponding to the answer content “4x” of the answer area in the first homework file, the analyzing module 13 of the server 10 extracts the answering content “2x+2x=4x” of the answering area corresponding to the answer content “4x” of the answer area in the second homework file, and the analyzing module 13 of the server 10 extracts the answering content “1x+3x=4x” of the answering area corresponding to the answer content “4x” of the answer area in the third homework file.

Next, similarity analysis is performed on the answering content “2x+2x=4x” of the first homework file and the answering content “2x+2x=4x” of the second homework file, it may be found through analysis that the answering content of the first homework file is completely consistent with the answering content of the second homework file, namely, a similarity value of the first homework file and the second homework file is “100”.

Next, similarity analysis is performed on the answering content “2x+2x=4x” of the first homework file and the answering content “1x+3x=4x” of the third homework file, it may be found through analysis that the answering content of the first homework file is not completely consistent with the answering content of the third homework file, namely, a similarity value of the first homework file and the third homework file is “60”.

Next, similarity analysis is performed on the answering content “2x+2x=4x” of the second homework file and the answering content “1x+3x=4x” of the third homework file, it may be found through analysis that the answering content of the second homework file is not completely consistent with the answering content of the third homework file, namely, a similarity value of the second homework file and the third homework file is “60”.

After the analyzing module 13 of the server 10 calculates a plurality of similarity values, the generating module 14 of the server 10 may generate a student number of the homework file with the similarity value exceeding a preset value into a plagiarizing list. The forgoing preset value may be pre-established in the server 10, or a teacher sets the preset value through the data providing client 20, which is merely exemplified herein, and does not limit the application scope of the present invention.

As the forgoing examples, the similarity values calculated by the analyzing module 13 of the server 10 are “100”, “60” and “60” respectively. If the preset value is “70”, it may be obtained that the similarity value “100” exceeds the preset value “70”; and if the student number of the first homework file is “987123123”, the student number of the second homework file is “987456456” and the student number of the third homework file is “987789789”, the generating module 14 of the server 10 may generate the student number “987123123” of the first homework file and the student number “987456456” of the second homework file into a plagiarizing list.

After the generating module 14 of the server 10 generates the plagiarizing list, the plagiarizing list may be transmitted to the data providing client 20 through the transmitting module 15 of the server 10, so the teacher may obtain the student number of the student who plagiarizes homework through the plagiarizing list.

Additionally, after completing the answering, the student establishes a homework file, and the homework file further records answering time of the student in each answering area. The analyzing module 13 of the server 10 analyzes the answering time, and the generating module 14 of the server 10 may generate the analysis of the analyzing module 13 of the server 10 on the answering time into an analysis result. Through the analysis result, whether the student spends too much time in writing homework may be known, and the analysis result is provided to the teacher as a basis for adjusting the homework.

Also, according to the answering time of each answering area recorded in the homework file, the generating module 14 of the server 10 may generate the student number of the homework file with the answering time less than a preset value and the similarity value exceeding a preset value into a plagiarizing list, which also indicates that the student spends too less time in writing homework, so the homework written by the student is very likely plagiarized.

Additionally, according to the answering time of each answering area recorded in the homework file, the generating module 14 of the server 10 may generate the student number of the homework file with the answering time less than different preset values corresponding to each answering area and the answer content consistent with the standard answer into a plagiarizing list. The different preset values corresponding to each answering area indicate the difference of the difficulty of the question area corresponding to the answering area, and the difference of the difficulty of the question area causes the difference of thinking time, calculating time and writing time of the student, so different preset values need to be set according to different difficulty. Even if the answer content is consistent with the standard answer, when the answering time is less than different preset values corresponding to each answering area, it also indicates that the student spends too less time in writing homework, so the homework written by the student may be very likely plagiarized.

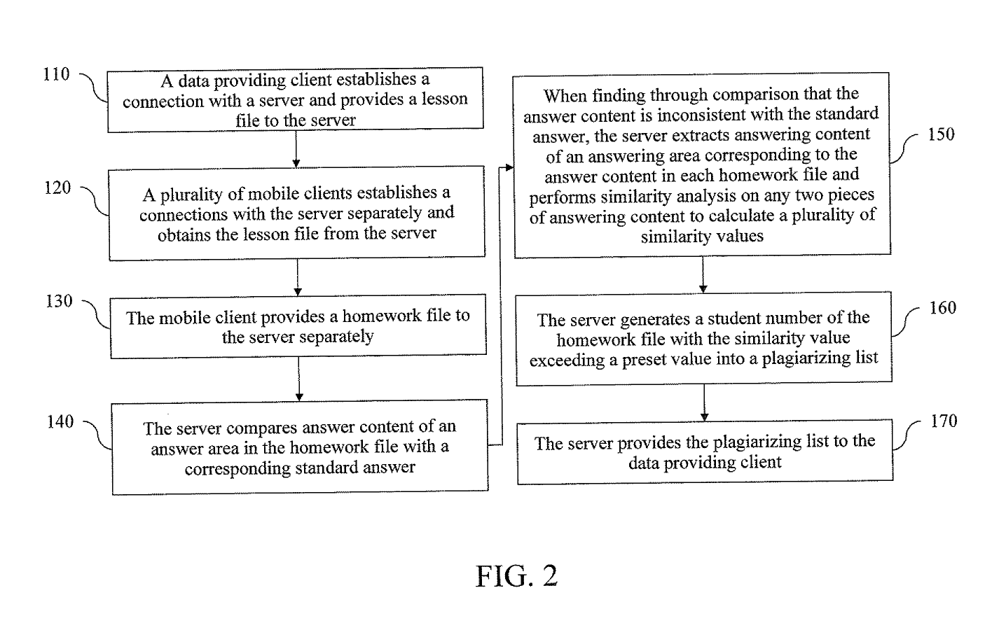

Next, the operation manner and the flow of the present invention are illustrated below in an embodiment, and the following embodiment is illustrated with reference to FIG. 1 and FIG. 2. FIG. 2 is a flow chart of a method for downloading student homework and analyzing homework of the present invention.

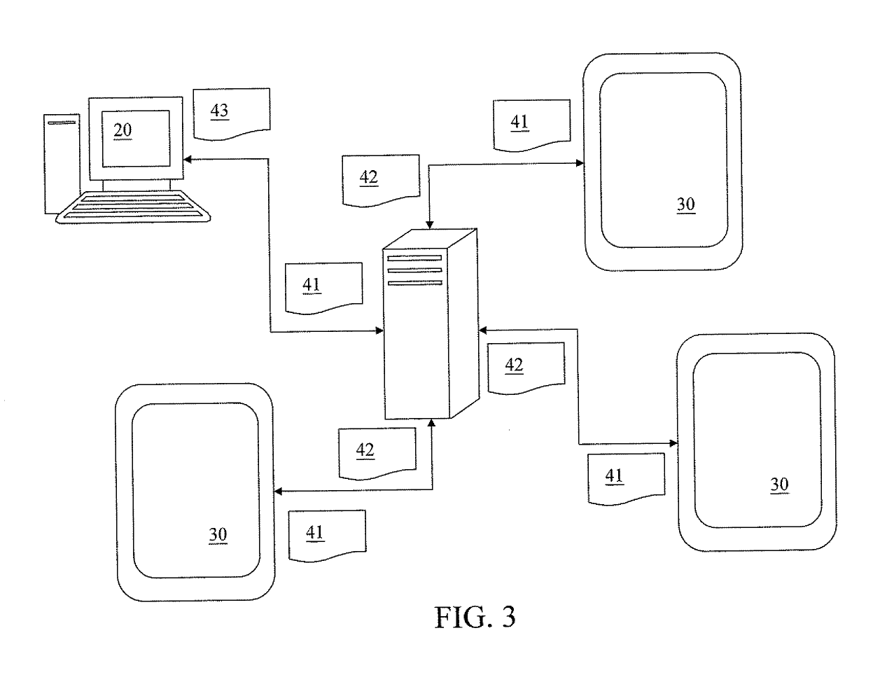

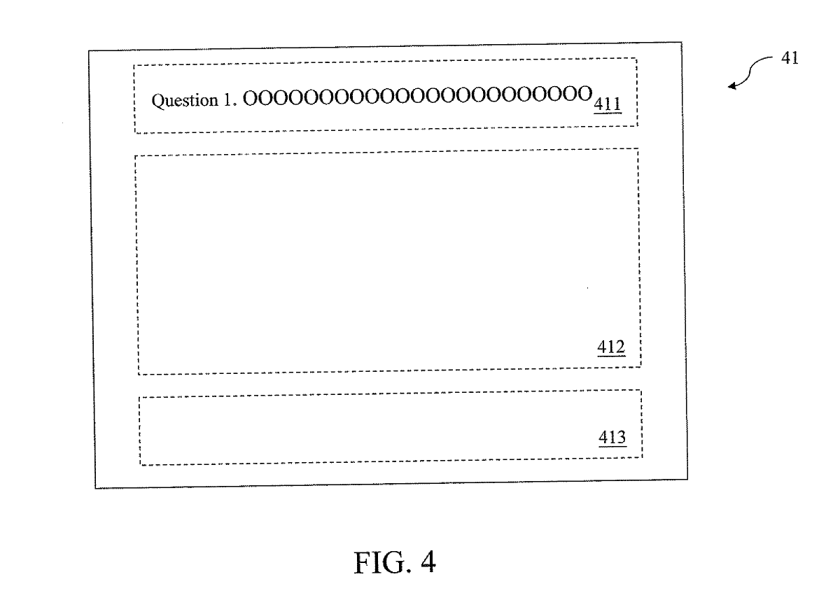

Referring to FIG. 3 and FIG. 4 at the same time, FIG. 3 is a schematic diagram of an architecture for downloading student homework and analyzing homework of the present invention. FIG. 4 is a schematic diagram of a lesson file for downloading student homework and analyzing homework of the present invention.

A teacher first uploads a lesson file 41 to a server 10 through a data providing client 20 that establishes a connection with the server 10 (step 110). The lesson file 41 includes a question area 411, an answering area 412 and an answer area 413, where the question area 411 is question content assigned by the teacher, the answering area 412 is answering process content of the student for the question, and the answer area 413 is answer content of the student for the question.

The data providing client 20 uploads the lesson file 41 to the server 10, such as establishes a connection with the server 10 in a wired network manner, and the data providing client 20 may provide the lesson file 41 to the receiving module 11 of the server 10. The forgoing data providing client 20 may be a desktop computer, a notebook computer, a tablet computer, a smartphone, and so on, which is merely exemplified herein, and does not limit the application scope of the present invention.

After receiving the lesson file provided by the data providing client 20, the receiving module 11 of the server 10 may store the lesson file in the server 10. When the student wants to write homework, the student obtains the lesson file 41 from the server 10 through a mobile client 30 held by the student to write the homework (step 120). The mobile client 30 may for example establish a connection with the server 10 in a WIFI wireless transmission manner, the transmitting module 15 of the server 10 transmits the lesson file 41 to the mobile client 30, and the mobile client 30 may obtain the lesson file from the server 10. The forgoing mobile client 30 may be a portable device such as a notebook computer, a tablet computer and a smartphone, which is merely exemplified herein, and does not limit the application scope of the present invention.

After the student obtains the lesson file 41 from the server 10 through the mobile client 30, the student may record an answering process in the answering area 412 of the lesson file 41, and record the answer in the answer area 413 of the lesson file 41. After completing the answering, the student establishes a homework file 42, where the homework file 42 includes the student number of the student, the homework file may be provided to the server 10 through the mobile client 30 (step 130).

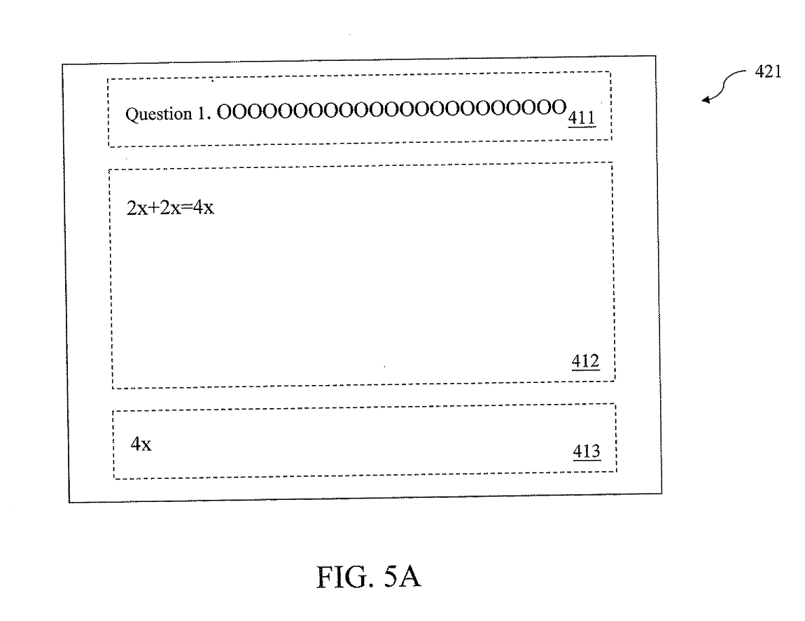

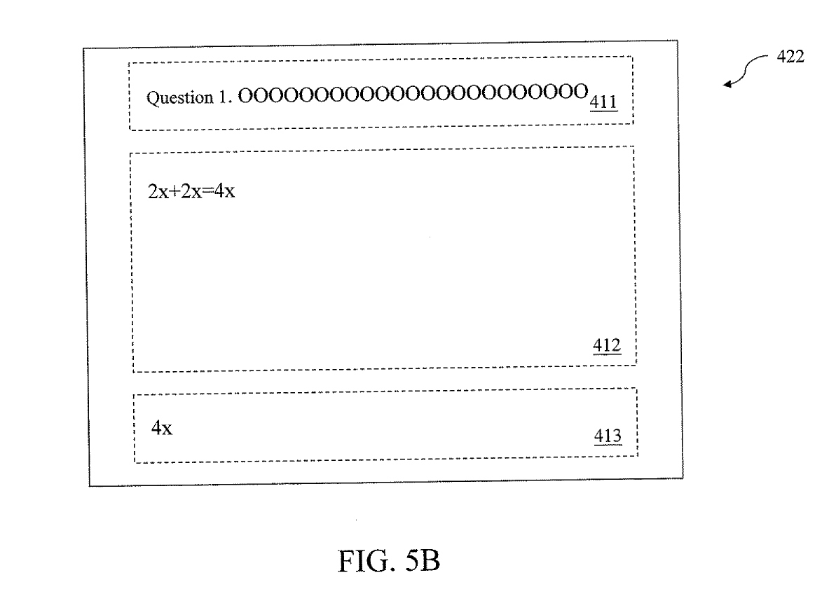

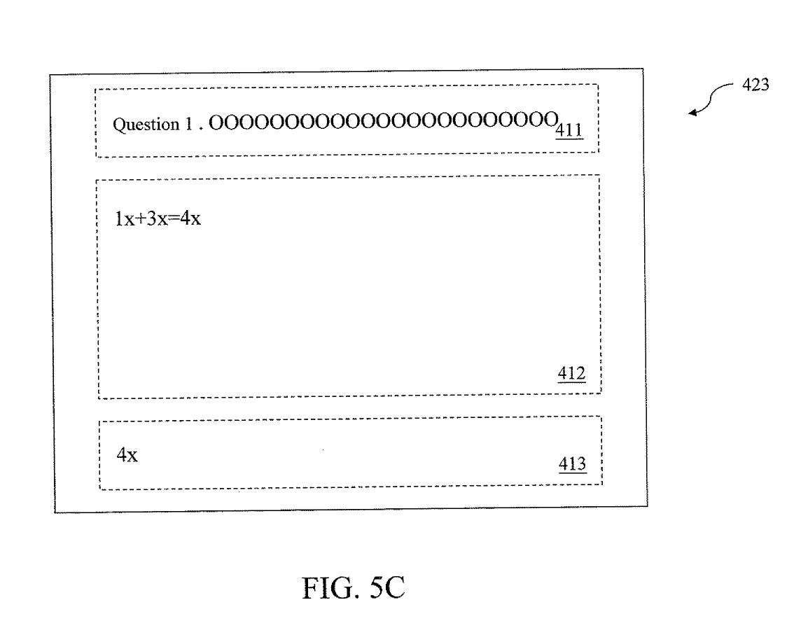

Next, referring to FIG. 3 and FIG. 5A to FIG. 5C, FIG. 5A is a schematic diagram of a first homework file for downloading student homework and analyzing homework of the present invention; FIG. 5B is a schematic diagram of a second homework file for downloading student homework and analyzing homework of the present invention; and FIG. 5C is a schematic diagram of a third homework file for downloading student homework and analyzing homework of the present invention.

After the receiving module 11 of the server 10 receives a first homework file 421, a second homework file 422 and a third homework file 423 provided by three mobile clients 30, the comparing module 12 of the server 10 may compare the answering content “2x+2x=4x” of an answering area 413 in the first homework file 421 with the answer content “4x” of the answer area corresponding to the answering area (step 140).

In the embodiment, the comparison result is that the answer content “4x” of the answer area 413 is inconsistent with a standard answer “5x”. At this time, the analyzing module 13 of the server 10 extracts the answering content “2x+2x=4x” of the answering area 412 corresponding to the answer content “4x” of the answer area 413 in the first homework file 421, extracts the answering content “2x+2x=4x” of the answering area 412 corresponding to the answer content “4x” of the answer area 413 in the second homework file 422, and extracts the answering content “1x+3x=4x” of the answering area 412 corresponding to the answer content “4x” of the answer area 413 in the third homework file 423.

Next, similarity analysis is performed on the answering content “2x+2x=4x” of the first homework file 421 and the answering content “2x+2x=4x” of the second homework file 422. It may be found through analysis that the answering content of the first homework file 421 is completely consistent with the answering content of the second homework file 422, namely, a similarity value of the first homework file 421 and the second homework file 422 is “100” (step 150).

Next, similarity analysis is performed on the answering content “2x+2x=4x” of the first homework file 421 and the answering content “1x+3x=4x” of the third homework file 423. It may be found through analysis that the answering content of the first homework file 421 is not completely consistent with the answering content of the third homework file 423, namely, a similarity value of the first homework file 421 and the third homework file 423 is “60” (step 150).

Next, similarity analysis is performed on the answering content “2x+2x=4x” of the second homework file 422 and the answering content “1x+3x=4x” of the third homework file 423. It may be found through analysis that the answering content of the second homework file 422 is not completely consistent with the answering content of the third homework file 423, namely, a similarity value of the second homework file 422 and the third homework file 423 is “60” (step 150).

The similarity values calculated by the analyzing module 13 of the server 10 are “100”, “60” and “60” respectively. If the preset value is “70”, it may be obtained that the similarity value “100” exceeds the preset value “70”. If the student number of the first homework file 421 is “987123123”, the student number of the second homework file 422 is “987456456” and the student number of the third homework file is “987789789”, the generating module 14 of the server 10 may generate the student number “987123123” of the first homework file 421 and the student number “987456456” of the second homework file 422 into a plagiarizing list 43 (step 160).

After the generating module 14 of the server 10 generates the plagiarizing list 43, the plagiarizing list 43 may be transmitted to the data providing client 20 through the transmitting module 15 of the server 10 (step 170). The teacher may obtain the student numbers “987123123” and “987456456” of the students who plagiarize homework through the plagiarizing list 43.

After completing the answering, the student establishes a homework file, and the homework file further records answering time of the student in each answering area. The analyzing module 13 of the server 10 analyzes the answering time, and the generating module 14 of the server 10 may generate the analysis of the analyzing module 13 of the server 10 on the answering time into an analysis result. Through the analysis result, whether the student spends too much time in writing the homework may be known, and the analysis result is provided to the teacher as a basis for adjusting the homework.

Also, according to the answering time of each answering area recorded in the homework file, the generating module 14 of the server 10 may generate the student number of the homework file with the answering time less than a preset value and the similarity value exceeding a preset value into a plagiarizing list, which also indicates that the student spends too less time in writing homework, so the homework written by the student is very likely plagiarized.

Additionally, according to the answering time of each answering area recorded in the homework file, the generating module 14 of the server 10 may generate the student number of the homework file with the answering time less than different preset values corresponding to each answering area and the answer content consistent with the standard answer into a plagiarizing list. The different preset values corresponding to each answering area indicate the difference of the difficulty of a question area corresponding to the answering area, and the difference of the difficulty of the question area causes the difference of thinking time, calculating time and writing time of the student, so different preset values need to be set according to different difficulty. Even if the answer content is consistent with the standard answer, when the answering time is less than the different preset values corresponding to each answering area, it also indicates that the student spends too less time in writing homework, so the homework written by the student is very likely plagiarized.

To sum up, it can be known that, the difference between the present invention and the prior art lies in that in the present invention, a teacher may upload a lesson file to a server through a data providing client for a student to download the lesson file conveniently, and when the student uploads a homework file to the server through a mobile client, the server may find wrong answer content to perform similarity analysis on any two pieces of answering content and calculate a plurality of similarity values, and provide a student number of the homework file with the similarity value exceeding a preset value to the data providing client, so the teacher may know the plagiarism situation of student homework fast.

Through the technical means, the problem existing in the prior art that digital homework is provided inconveniently and plagiarism of the digital homework is compared inconveniently may be solved, so as to achieve the technical efficacy of providing digital homework to a student conveniently and analyzing student homework plagiarism fast.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for downloading student homework and analyzing homework, comprising:
a server, further comprising:
a receiving module, used for receiving a lesson file and receiving a plurality of homework files:
a comparing module, used for comparing answer content of an answer area in the homework file with a corresponding standard answer;
an analyzing module, used for, when the comparing module finds through comparison that the answer content is inconsistent with the standard answer, extracting answering content of an answering area corresponding to the answer content in each homework file and performing similarity analysis on any two pieces of answering content to calculate a plurality of similarity values;
a generating module, used for generating a student number of the homework file with the similarity value exceeding a preset value into a plagiarizing list; and
a transmitting module, used for transmitting the lesson file and transmitting the plagiarizing list;
a data providing client, used for establishing a connection with the server, providing the lesson file to the receiving module, and obtaining the plagiarizing list from the transmitting module; and
plurality of mobile clients, used for establishing connections with the server separately, obtaining the lesson file from the transmitting module, and providing the homework file to the receiving module.

2. The system for downloading student homework and analyzing homework according to claim 1, wherein the homework file further records answering time of each answering area, and the generating module generates the student number of the homework file with the answering time less than a preset value and the similarity value exceeding a preset value into the plagiarizing list,

3. The system for downloading student homework and analyzing homework according to claim 1, wherein the homework file further records answering time of each answering area, the analyzing module analyzes the answering time, and the generating module generates the analysis of the answering time into an analysis result.

4. The system for downloading student homework and analyzing homework according to claim 1, wherein the homework file further records answering time of each answering area, and the generating module generates the student number of the homework file with the answering time less than different preset values corresponding to each answering area and the answer content consistent with the standard answer into the plagiarizing list.

5. The system for downloading student homework and analyzing homework according to claim 1, wherein the data providing client establishes a connection with the server is in a wired transmission manner or a wireless transmission manner and the mobile client establishes a connection with the server in a wired transmission manner or a wireless transmission manner.

6. A method for downloading student homework and analyzing homework, comprising the following steps:
establishing a connection by a data providing client with a server, and providing a lesson file to the server;
establishing connections by plurality of mobile clients with the server separately, and obtaining the lesson file from the server;
providing a homework file by the mobile client to the server separately;
comparing answer content of an answer area in the homework file by the server with a corresponding standard answer;
extracting answering content of an answering area corresponding to the answer content in each homework file and performing similarity analysis on any two pieces of answering content to calculate a plurality of similarity values when the server finds through comparison that the answer content is inconsistent with the standard answer;
generating a student number of the homework file with the similarity value exceeding a preset value by the server into a plagiarizing list; and
providing the plagiarizing list by the server to the data providing client.

7. The method for downloading student homework and analyzing homework according to claim 6, wherein in the step of providing the homework file by the mobile client to the server separately, the homework file further records answering time of each answering area, and the server generates the student number of the homework file with the answering time less than a preset value and the similarity value exceeding a preset value into the plagiarizing list.

8. The method for downloading student homework and analyzing homework according to claim 6, wherein in the step of providing the homework file by the mobile client to the server separately, the homework file further records answering time of each answering area, the server analyzes the answering time, and the generating module generates the analysis of the answering time into an analysis result.

9. The method for downloading student homework and analyzing homework according to claim 6, wherein in the step of providing the homework file by the mobile client to the server separately, the homework file further records answering time of each answering area, and the server generates the student number of the homework file with the answering time less than different preset values corresponding to each answering area and the answer content consistent with the standard answer into the plagiarizing list.

10. The method for downloading student homework and analyzing homework according to claim 6, wherein in the step of establishing a connection by the data providing client with the server, the data providing client establishes a connection with the server in a wired transmission manner or a wireless transmission manner, and in the step of establishing a connection by the mobile client with the server separately, the mobile client establishes a connection with the server in a wired transmission manner or in a wireless transmission manner.
